(19) United States
(12) Patent Application Publication
(10) Pub. No.: US 2026/0160864 A1
(43) Pub. Date: Jun. 11, 2026

(54) DISTANCE MEASURING DEVICE AND LIGHT DETECTION ELEMENT

(71) Applicant: SONY SEMICONDUCTOR SOLUTIONS CORPORATION, KANAGAWA (JP)

(72) Inventor: KOSUKE SHIMIZU, KANAGAWA (JP)

(21) Appl. No.: 18/705,609

(22) PCT Filed: Sep. 9, 2022
(86) PCT No.: PCT/JP2022/033860

§ 371 Date: Apr. 29, 2024

(30) Foreign Application Priority Data
Nov. 5, 2021 (JP) 2021-181377

(51) Int. Cl. G01S 7/484; G01S 7/481; G01S 7/4865; G01S 17/10

(52) U.S. Cl. CPC G01S 7/484; G01S 7/4816; G01S 7/4865; G01S 17/10

(57) ABSTRACT

A frame rate is increased in a distance measuring device using the ToF scheme. A light emission driving unit drives a light emitting unit in synchronization with a driving clock signal. A driving clock generation unit generates the driving clock signal. A high frequency clock generation unit generates a high frequency clock signal having a higher frequency than the driving clock signal. A sequence control unit transmits a predetermined control signal to the light emission driving unit in synchronization with the high frequency clock signal within a change period from the start to the end of a change of a frequency of the driving clock signal.

### TECHNICAL FIELD

The present technology relates to a distance measuring device. Specifically, the present technology relates to a distance measuring device that measures a distance from a time of flight of light, and a light detection element.

### BACKGROUND ART

Conventionally, a distance measurement scheme called a time of flight (ToF) scheme had been used in electronic devices having distance measurement functions. The ToF scheme is a scheme of measuring a distance by irradiating a subject with irradiation light and obtaining a time of flight until the irradiation light is reflected and returned. For example, there is proposed a distance measuring module in which a drive unit drives a light emitting unit to emit laser light, and an image sensor receives reflected light of the laser light to measure a distance by a ToF scheme (see, for example, Patent Document 1).

### CITATION LIST

### Patent Document

Patent Document 1: Japanese Patent Application Laid-Open No. 2020-20681

### SUMMARY OF THE INVENTION

### Problems to be Solved by the Invention

In the above-described related art, the image sensor is used to capture image data (In other words, frames) in which a plurality of distance data is arranged. However, it is difficult to further increase a frame rate in the above-described light detection element. In particular, a blank period in which a clock signal cannot be used and light emission is interrupted occurs when a frequency of the clock signal indicating a light emission timing is changed. The frame rate decreases as the blank period increases, which is problematic.

The present technology has been made in view of such a situation, and aims to increase a frame rate in a distance measuring device using a ToF scheme.

### Solutions to Problems

The present technology has been made to solve the above-described problems, and a first aspect thereof is a distance measuring device including: a light emission driving unit that drives a light emitting unit in synchronization with a driving clock signal having a frequency higher than a predetermined frequency; a driving clock generation unit that generates the driving clock signal; a high frequency clock generation unit that generates a high frequency clock signal having a frequency higher than the predetermined frequency; and a sequence control unit that transmits a predetermined control signal to the light emission driving unit in synchronization with the high frequency clock signal within a change period from the start to the end of a change of the frequency of the driving clock signal. This brings about an effect that a frame rate is improved.

Furthermore, in the first aspect, the high frequency clock generation unit may stop in a case where a predetermined low power mode is set, and the sequence control unit may transmit the control signal to the light emission driving unit in synchronization with the high frequency clock signal within the change period in a case where the low power mode is not set, and transmit the control signal to the light emission driving unit in synchronization with the driving clock signal before the start of the change period in a case where the low power mode is set. This brings about an effect that prolongation of the change period is suppressed in the low power mode.

Furthermore, in the first aspect, the control signal may include any of a first setting value, a second setting value, and a command for instructing a change from the first setting value to the second setting value, the sequence control unit may transmit the second setting value to the light emission driving unit in synchronization with the driving clock signal before the start of the change period, and transmit the command to the light emission driving unit in synchronization with the high frequency clock signal within the change period, and the light emission driving unit may hold the second setting value in a predetermined holding unit before the start of the change period, read the second setting value from the holding unit when the command is transmitted, and drive the light emitting unit on the basis of the second setting value. This brings about an effect that the change period is shortened.

Furthermore, in the first aspect, a pixel array unit in which pixels each generating a pulse signal in response to incidence of a photon are arranged, and a time-to-digital converter that obtains a time of flight of light from the pulse signal and the driving clock signal may be further provided. This brings about an effect that the time of flight is measured.

Furthermore, in the first aspect, a distance data generation unit that generates distance data indicating a distance to a subject on the basis of the time of flight may be further provided. This brings about an effect that the distance is measured by a ToF scheme.

Furthermore, in the first aspect, a selector that selects the driving clock signal outside the change period and supplies the driving clock signal to the sequence control unit, and selects the high frequency clock signal within the change period and supplies the high frequency clock signal to the sequence control unit may be further provided. This brings about an effect that the clock signal can be switched.

Furthermore, a second aspect of the present technology is a light detection element including: a driving clock generation unit that generates a driving clock signal having a frequency higher than a predetermined frequency and indicating a timing to drive a light emitting unit; a high frequency clock generation unit that generates a high frequency clock signal having a frequency higher than the predetermined frequency; a timing generation unit that supplies the driving clock signal to a light emission driving unit that drives the light emitting unit in synchronization with the driving clock signal; and a sequence control unit that transmits a predetermined control signal to the light emission driving unit in synchronization with the high frequency clock signal within a change period from the start to the end of a change of the frequency of the driving clock signal. This brings about an effect that a frame rate of a frame generated by the light detection element is improved.

### BRIEF DESCRIPTION OF DRAWINGS

FIG. 1 is a block diagram illustrating a configuration example of a distance measuring system in a first embodiment of the present technology.

FIG. 2 is a block diagram illustrating a configuration example of a light detection element in the first embodiment of the present technology.

FIG. 3 is a diagram illustrating a mounting example of a distance measuring module in the first embodiment of the present technology.

FIG. 4 is a diagram illustrating a layout example of light emitting elements in the first embodiment of the present technology.

FIG. 5 is a block diagram illustrating a configuration example of a column signal processing unit in the first embodiment of the present technology.

FIG. 6 is a block diagram illustrating a configuration example of a clock distribution unit, a signal processing circuit, and a distance data transmission circuit in the first embodiment of the present technology.

FIG. 7 is a block diagram illustrating a configuration example of a light emission driving unit in the first embodiment of the present technology.

FIG. 8 is a sequence diagram illustrating an example of an operation of the distance measuring system in the first embodiment of the present technology.

FIG. 9 is a timing chart illustrating an example of operation in a normal mode of the light detection element in the first embodiment of the present technology.

FIG. 10 is a timing chart illustrating an example of operation in a low power mode of the light detection element in the first embodiment of the present technology.

FIG. 11 is a timing chart illustrating an example of operation in a frequency change of the light detection element in the first embodiment of the present technology.

FIG. 12 is a timing chart illustrating an example of operation in a normal mode of a light detection element in a comparative example.

FIG. 13 is a timing chart illustrating an example of operation in a normal mode of a light detection element in a second embodiment of the present technology.

FIG. 14 is a block diagram illustrating a schematic configuration example of a vehicle control system.

FIG. 15 is an explanatory diagram illustrating an example of an installation position of an imaging section.

### MODE FOR CARRYING OUT THE INVENTION

Modes for carrying out the present technology (hereinafter referred to as embodiments) will be described below. The description will be given in the following order.
1. First Embodiment (Example in which Another Clock Signal Is Used During Change of Frequency of Clock Signal for Driving)
2. Second Embodiment (Example in which Command Is Transmitted in Synchronization with Another Clock Signal during Change of Frequency of Clock Signal for Driving)
3. Application Example to Mobile Body

### 1. First Embodiment

### Configuration Example of Distance Measuring System

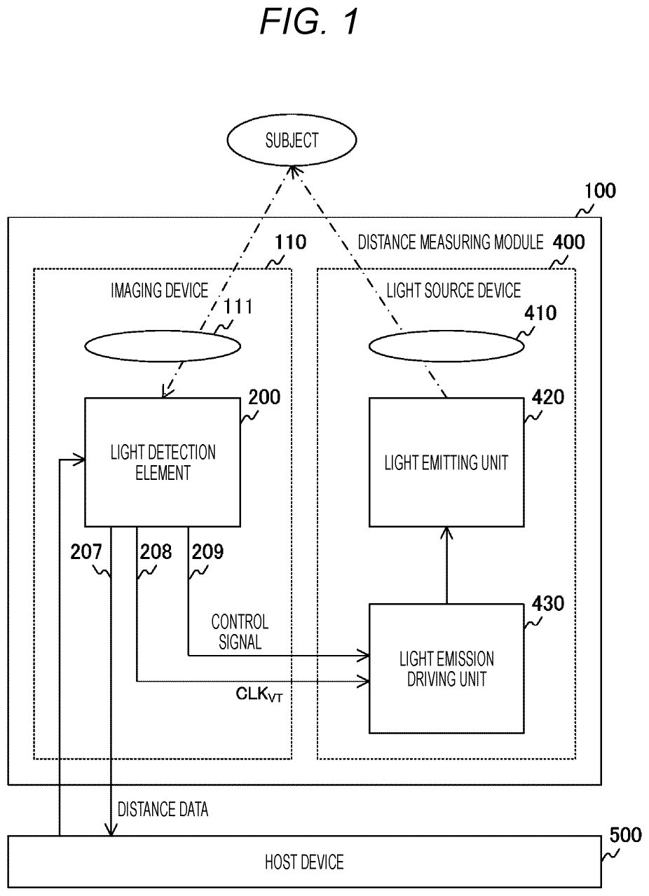

FIG. 1 is a block diagram illustrating a configuration example of a distance measuring system in a first embodiment of the present technology. This distance measuring system is a system for measuring a distance to a subject, and includes a distance measuring module 100 and a host device 500. The distance measuring module 100 includes an imaging device 110 and a light source device 400. The light source device 400 emits irradiation light such as laser light to irradiate the subject. The imaging device 110 receives reflected light of the irradiation light, and captures image data (frames) in which a plurality of distance data is arranged in a two-dimensional lattice shape. Arrows of alternate long and short dash lines in the drawing indicate respective optical paths of the irradiation light and the reflected light. Solid arrows indicate transmission paths of various electric signals. Note that the distance measuring module 100 is an example of a distance measuring device described in the claims.

The imaging device 110 includes an imaging-side optical system 111 and a light detection element 200. The imaging-side optical system 111 includes a predetermined number of lenses, collects the reflected light, and guides the reflected light to the light detection element 200. The light detection element 200 generates a frame under the control of the host device 500 and supplies the frame to the host device 500 via a signal line 207. Furthermore, the light detection element 200 generates a clock signal CLK_{VT} indicating a timing to drive a light emitting unit 420, and supplies the clock signal CLK_{VT} to a light emission driving unit 430 via a signal line 208. Moreover, the light detection element 200 generates a predetermined control signal and supplies the control signal to the light emission driving unit 430 via a signal line 209. Details of the control signal will be described later. As the light detection element 200, for example, a solid-state imaging element is used.

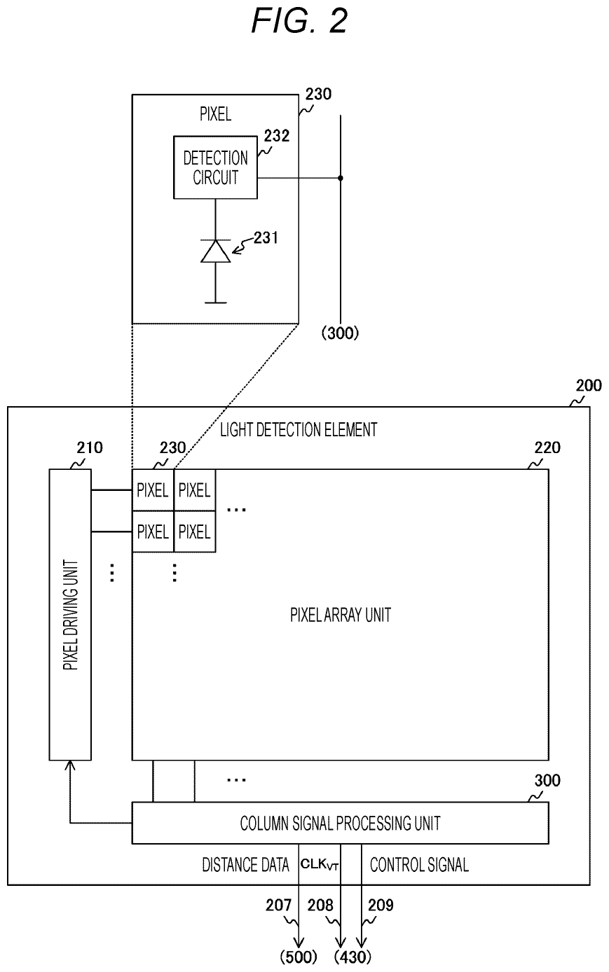

Although only one signal line 207, one signal line 208, and one signal line 209 are illustrated in the drawing, the number of each of the signal lines is not physically limited to one, and a plurality of signal lines may be provided. For example, low voltage differential signaling (LVDS) can be used as a communication interface to transmit the clock signal CLK_{VT}, and in this case, two signal lines 208 are wired. Furthermore, for example, a serial peripheral interface (SPI) can be used as a communication interface to transmit the control signal, and in this case, four signal lines 209 are wired. This similarly applies to FIG. 2 and the subsequent drawings.

The light source device 400 includes a light-emitting-side optical system 410, the light emitting unit 420, and the light emission driving unit 430. The light-emitting-side optical system 410 collects the irradiation light. In the light emitting unit 420, a plurality of light emitting elements (not illustrated) is arranged in a two-dimensional lattice shape. As these light emitting elements, for example, vertical cavity surface emitting laser (VCSEL) elements are used. The clock signal CLK_{VT} is used as a trigger signal for driving the VCSEL. The light emission driving unit 430 drives the light emitting unit 420 in synchronization with the clock signal CLK_{VT}. For example, a laser driver is used as the light emission driving unit 430.

The host device 500 controls the light detection element 200 to capture an image of the frame.

### Configuration Example of Light Detection Element

FIG. 2 is a block diagram illustrating a configuration example of the light detection element 200 in the first embodiment of the present technology. The light detection element 200 includes a pixel driving unit 210, a pixel array unit 220, and a column signal processing unit 300. In the pixel array unit 220, a plurality of pixels 230 is arranged in a two-dimensional lattice manner.

The pixel 230 generates a pulse signal in response to incidence of a photon. The pixel 230 supplies the pulse signal to the column signal processing unit 300 for each of columns. Each of the pixels 230 is provided with, for example, a single-photon avalanche diode (SPAD) 231 and a detection circuit 232. The detection circuit 232 generates the pulse signal on the basis of a voltage of an anode or a cathode of the SPAD 231.

The column signal processing unit 300 generates distance data by a direct time of flight (dToF) scheme on the basis of the pulse signal of each of the columns. The column signal processing unit 300 supplies the distance data to the host device 500 via the signal line 207. Furthermore, the column signal processing unit 300 supplies the clock signal CLK_{VT} and the control signal to the light emission driving unit 430 via the signal lines 208 and 209.

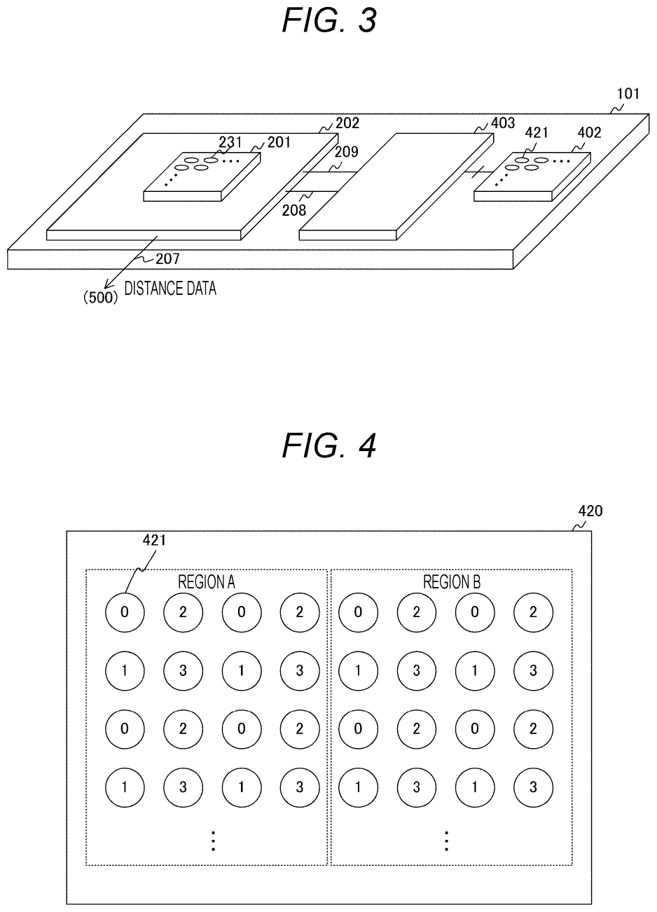

FIG. 3 is a diagram illustrating a mounting example of the distance measuring module 100 in the first embodiment of the present technology. Elements and circuits in the distance measuring module 100 are mounted on a semiconductor substrate 101. On the semiconductor substrate 101, stacked upper chip 201 and lower chip 202, a chip 402, and a chip 403 are disposed.

In the upper chip 201, a plurality of the SPADs 231 is arranged in a two-dimensional lattice shape. In the lower chip 202, circuits (the detection circuit 232 and the column signal processing unit 300) at subsequent stages of the SPADs 231 are disposed. These chips function as the light detection element 200.

Furthermore, the chip 403 includes circuits and elements in the light emission driving unit 430, and functions as the light emission driving unit 430.

The chip 402 includes a plurality of light emitting elements 421 (such as VCSEL elements) is arranged in a two-dimensional lattice shape, and functions as the light emitting unit 420.

Note that a method for mounting the distance measuring module 100 is not limited to that illustrated in the drawing. For example, the light detection element 200 does not necessarily have a stacked structure, and the circuits or elements may be mounted on the single semiconductor chip.

FIG. 4 is a diagram illustrating a layout example of the light emitting elements 421 in the first embodiment of the present technology. As illustrated in the drawing, the plurality of light emitting elements 421 are arranged in a two-dimensional lattice shape on the light emitting surface of the light emitting unit 420. Banks are assigned to the light emitting elements 421, respectively, in accordance with positions on a light emitting surface. Here, the bank is, for example, identification information for specifying a driving target among the plurality of light emitting elements 421. Numerical values in the drawing indicate numbers of the banks. In the drawing, any of bank #0, bank #1, bank #2, and bank #3 is assigned to each of the light emitting elements 421. From the viewpoint of power saving, the light emission driving unit 430 performs distance measurement by thinning out some of the light emitting elements 421 without causing all of the light emitting elements 421 to emit light. For example, when an image of one frame is captured, three of the banks #0 to #3 are thinned out, and only the remaining one bank is driven. Note that the light emission driving unit 430 can also cause all of the light emitting elements 421 to emit light.

Among the plurality of light emitting elements 421, the light emitting elements 421 belonging to the same bank are controlled to repeatedly emit light at a predetermined distance measurement cycle during the same sampling period. Here, the sampling period corresponds to a period for generating one frame, and can also be referred to as an exposure period of the frame. Furthermore, the distance measurement cycle is equal to a light emission cycle of irradiation light and corresponds to a cycle of the clock signal CLK_{VT} described above.

Regarding the irradiation light emitted from the light emitting elements 421 belonging to the same bank, a time of flight from reflection by the subject to reception by the light detection element 200 is repeatedly measured by the light detection element 200 during the same sampling period (exposure period).

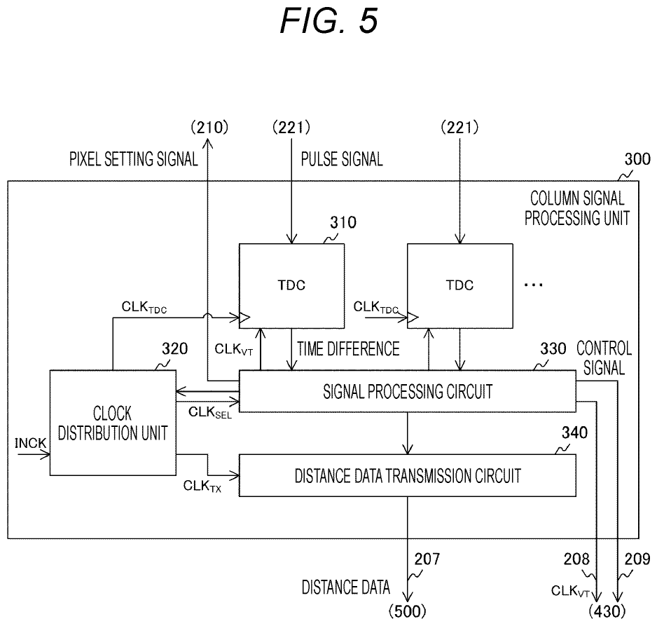

Note that the arrangement of the plurality of light emitting elements 421 can also be divided into a plurality of regions. Regions A and B in the drawing indicate divided regions. The light emitting elements 421 divided into different regions are driven to emit light during different periods even if belonging to the same bank. Therefore, even if an energy of irradiation light from each of the light emitting elements 421 is increased, it is possible to reduce an average energy of beams of irradiation light emitted from the respective light emitting elements 421 during a predetermined period. A driving method in the case of being divided into the plurality of regions is described in, for example, FIG. 5 of Japanese Patent Application Laid-Open No. 2021-120630.

Furthermore, four banks are assigned in the drawing, but the number of banks can be changed by the control of the light detection element 200. As the number of banks increases, the amount of thinning when any bank is selected increases, and power consumption can be reduced. Furthermore, the number of times of distance measurement within the exposure period can also be changed, and distance measurement accuracy can be improved as the number of times of distance measurement is increased. It is necessary to interrupt light emission for a certain period between an exposure period of a certain frame and an exposure period of a next frame, and this period is referred to as a “blank period”. It is necessary to minimize the blank period in order to increase the number of banks and the number of times of distance measurement without decreasing a frame rate.

### Configuration Example of Column Signal Processing Unit

FIG. 5 is a block diagram illustrating a configuration example of the column signal processing unit 300 in the first embodiment of the present technology. The column signal processing unit 300 includes a plurality of TDCs 310, a clock distribution unit 320, a signal processing circuit 330, and a distance data transmission circuit 340.

The TDCs 310 are provided for the columns, respectively. A clock signal CLK_{TDC} from the clock distribution unit 320, the clock signal CLK_{VT} from the signal processing circuit 330, and the pulse signal from the corresponding column are input to each of the TDCs 310. The TDC 310 converts a time difference between a driving timing indicated by the clock signal CLK_{VT} and a light reception timing of reflected light indicated by the pulse signal into a digital signal in synchronization with the clock signal CLK_{TDC}. This time difference indicates a time of flight of light.

A clock signal INCK is input to the clock distribution unit 320. The clock distribution unit 320 multiplies the clock signal INCK to generate the clock signal CLK_{TDC}, a clock signal CLK_{SEL}, and a clock signal CLK_{TX}, and supplies the clock signals CLK_{TDC}, CLK_{SEL}, and CLK_{TX} to the TDC 310, the signal processing circuit 330, and the distance data transmission circuit 340, respectively.

The signal processing circuit 330 performs predetermined signal processing on the digital signal from the TDC 310 and measures a distance for each of the pixels. The signal processing circuit 330 supplies distance data for each of the pixels indicating a result of the distance measurement to the distance data transmission circuit 340. Furthermore, the signal processing circuit 330 generates the clock signal CLK_{VT}, supplies the clock signal CLK_{VT} to the TDC 310 and the light emission driving unit 430, and supplies the control signal to the light emission driving unit 430. Furthermore, the signal processing circuit 330 supplies a pixel setting signal indicating a pixel to be driven to the pixel driving unit 210.

The distance data transmission circuit 340 transmits pieces of the distance data to the host device 500 in synchronization with the clock signal CLK_{TX}.

### Configuration Example of Clock Distribution Unit, Signal Processing Circuit, and Distance Data Transmission Circuit

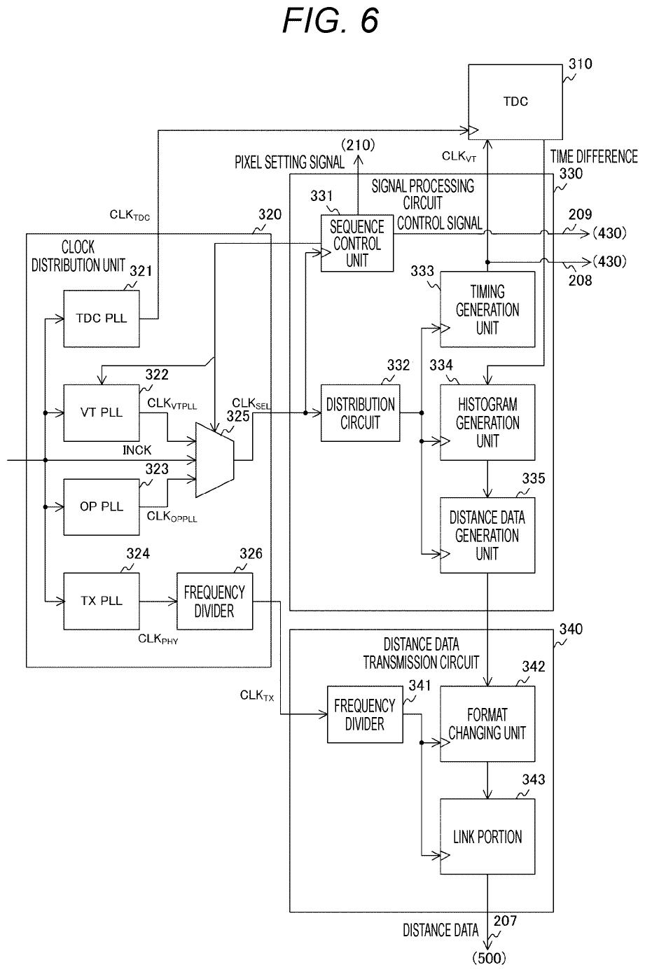

FIG. 6 is a block diagram illustrating a configuration example of the clock distribution unit 320, the signal processing circuit 330, and the distance data transmission circuit 340 in the first embodiment of the present technology. The clock distribution unit 320 includes a TDC PLL 321, a VT PLL 322, an OP PLL 323, a TX PLL 324, a selector 325, and a frequency divider 326. The signal processing circuit 330 includes a sequence control unit 331, a distribution circuit 332, a timing generation unit 333, a histogram generation unit 334, and a distance data generation unit 335. The distance data transmission circuit 340 includes a frequency divider 341, a format changing unit 342, and a link portion 343.

The clock signal INCK is input to the TDC PLL 321. The TDC PLL 321 multiplies the clock signal INCK to generate the clock signal CLK_{TDC}, and supplies the clock signal CLK_{TDC} to the TDC 310 of each of the columns.

The clock signal INCK is input to the VT PLL 322. The VT PLL 322 multiplies the clock signal INCK to generate a clock signal CLK_{VTPLL}, and supplies the clock signal CLK_{VTPLL} to the selector 325. Furthermore, the VT PLL 322 changes a multiplication ratio under the control of the sequence control unit 331.

The clock signal INCK is input to the OP PLL 323. The OP PLL 323 multiplies the clock signal INCK to generate a clock signal CLK_{OPPLL}, and supplies the clock signal CLK_{OPPLL} to the selector 325. The clock signal CLK_{OPPLL} is used for transmission of the control signal for operating the light emission driving unit 430.

The clock signal INCK is input to the TX PLL 324. The TX PLL 324 multiplies the clock signal INCK to generate a clock signal CLK_{PHY}, and supplies the clock signal CLK_{PHY} to the frequency divider 326.

Here, frequencies of the clock signals INCK, CLK_{TDC}, CLK_{VTPLL}, CLK_{TOPPLL}, and CLK_{PHY} are denoted by f_{IN}, f_{TDC}, f_{VT}, f_{OP}, and f_{PHY}, respectively. It is assumed that the following relational expression holds for values of these frequency.

$${f}_{IN} < {f}_{VT} , {f}_{OP} < {f}_{TDC} , {f}_{PHY} \qquad Formula 1$$

In the above-described formula, the magnitude relationship between the frequencies f_{VT} and f_{OP} is arbitrary. Furthermore, the magnitude relationship between the frequencies f_{TDC} and f_{PHY} is arbitrary. Furthermore, the frequency f_{VT} is variable, but the value thereof is changed within a range satisfying the above formula.

The selector 325 selects any of the clock signals INCK, CLK_{VTPLL}, and CLK_{TOPPLL} under the control of the sequence control unit 331, and supplies the selected clock signal as CLK_{SEL} to the signal processing circuit 330.

The frequency divider 326 frequency-divides the clock signal CLK_{PHY} and supplies the divided signal as CLK_{TX} to the distance data transmission circuit 340.

Here, any of a plurality of modes including a normal mode and a low power mode is set in the light detection element 200 by the host device 500. The normal mode is a mode in which the light detection element 200 continuously generates a plurality of frames in synchronization with a vertical synchronization signal or the like and supplies the frames to the host device 500.

On the other hand, the low power mode is a mode in which the light detection element 200 operates in a state of lower power consumption than the normal mode. In the low power mode, the OP PLL 323 and the TX PLL 324 stop as necessary, and the light detection element 200 stops transmitting a frame to the host device 500. Whether or not to stop the OP PLL 323 and the TX PLL 324 is determined on the basis of an exposure period, a frame rate, a data output timing, and the like. In a case where the frame transmission is stopped, the light detection element 200 holds a frame generated during the low power mode in a predetermined buffer (not illustrated), and reads the frame from the buffer and transmits the frame when returning to the normal mode.

In the signal processing circuit 330, the sequence control unit 331 supplies the pixel setting signal and the control signal to the pixel driving unit 210 and the light emission driving unit 430. Although the frequency of the clock signal CLK_{VTPLL} is variable as described above, when the frequency is changed, the light emission driving unit 430 cannot use the clock signal CLK_{VTPLL} during the change of the frequency, and the light emission is interrupted. Since the light emission should not be interrupted during an exposure period of a frame, the change of the frequency is performed within the blank period between frames.

The sequence control unit 331 controls the multiplication ratio of the VT PLL 322 at a timing set by the host device 500 and changes the frequency of the clock signal CLK_{VTPLL}. Furthermore, the sequence control unit 331 controls the selector 325 to select one of the three clock signals. The sequence control unit 331 outputs the clock signal CLK_{VTPLL} as CLK_{SEL} in a period (such as an exposure period) other than a frequency change period.

Furthermore, in a case where the frequency of the clock signal CLK_{VTPLL} is changed, the sequence control unit 331 controls the selector 325 to switch a clock signal to be output within the change period from the start to the end of the change of the frequency.

In a case where the frequency is changed in the normal mode, the sequence control unit 331 outputs the clock signal CLK_{OPPLL} as CLK_{SEL} instead of the clock signal CLK_{VTPLL} within the frequency change period since the OP PLL 323 is operating.

On the other hand, in a case where the frequency is changed in the low power mode, the sequence control unit 331 outputs the clock signal INCK as CLK_{SEL} instead of the clock signal CLK_{VTPLL} within the frequency change period since the OP PLL 323 stops.

Furthermore, in the case where the frequency is changed in the normal mode, the sequence control unit 331 transmits the control signal in synchronization with the clock signal CLK_{SEL} within the blank period. In a case where a bank is changed in the normal mode, the sequence control unit 331 transmits the pixel setting signal and the control signal in synchronization with the clock signal CLK_{SEL} within the blank period.

At the time of changing the frequency, for example, a control signal including various setting values related to the operation of the light emission driving unit 430 after the change is transmitted. Furthermore, in a case where the bank is changed, a control signal including a changed bank is transmitted to the light emission driving unit 430, and pixel setting information for setting a pixel corresponding to the changed bank as a driving target is transmitted to the pixel driving unit 210.

Here, in a case where the bank is also switched at the time of changing the frequency in the normal mode, a length T_{B} of the blank period during the frequency change is expressed by the following formula.

$${T}_{B} = MAX ( {T}_{PIX} , {T}_{TX} + {T}_{WAIT} , {T}_{f} ) \qquad Formula 2$$

In the above formula, MAX( ) is a function that returns the largest value among a plurality of values. T_{PIX} is a transmission time of the pixel setting signal. T_{TX} is a transmission time of the control signal. T_{WAIT} is a time until the light emission driving unit 430 is stabilized since completion of transmission of the control signal. T_{f} is a length of the change period from the start to the end of the frequency change.

On the other hand, in a case where the frequency is changed but the bank is not switched in the normal mode, the larger one of T_{TX}+T_{WAIT} or T_{f} is set to T_{B}. In a case where the bank is switched but the frequency is not changed, the larger one of T_{PIX} or T_{f} is set to T_{B}.

In the normal mode, the clock signal CLK_{OPPLL} having a higher frequency than the clock signal INCK is output as CLK_{SEL} during the frequency change of the clock signal CLK_{VTPLL} as described above. Therefore, the sequence control unit 331 can transmit the control signal in synchronization with the clock signal CLK_{OPPLL}.

On the other hand, in the low power mode, the clock signal INCK having a lower frequency is output as CLK_{SEL} during the frequency change of the clock signal CLK_{VTPLL}. Therefore, if the pixel setting signal or the control signal is transmitted within the change period, the transmission time T_{PIX} or T_{TX} becomes longer, and accordingly, the blank period becomes longer. In this regard, in the low power mode, the sequence control unit 331 transmits the pixel setting signal and the control signal in advance in synchronization with the clock signal CLK_{SEL} (CLK_{VTPLL}) before the start of the frequency change. Therefore, the blank period can be made shorter than that in a case where the pixel setting signal and the like are transmitted within the frequency change period.

The distribution circuit 332 distributes the clock signal CLK_{SEL} to the timing generation unit 333, the histogram generation unit 334, and the distance data generation unit 335.

The timing generation unit 333 supplies the clock signal CLK_{SEL} to the TDC 310 and the light emission driving unit 430 as the clock signal CLK_{VT} in a period that does not correspond to the frequency change period. On the other hand, the timing generation unit 333 stops in the frequency change period.

The histogram generation unit 334 generates a histogram for each of the pixels on the basis of the digital signal (time difference) output from the TDC 310. The histogram indicates, for each value of the digital signal, the number of times the value is output within an exposure period as a frequency, for example. The histogram generation unit 334 supplies the generated histogram to the distance data generation unit 335.

The distance data generation unit 335 generates distance data for each of the pixels on the basis of the histogram. The distance data generation unit 335 specifies a time difference (time of flight) corresponding to a peak value of the histogram, and generates the distance data from the time of flight by the following formula.

$$L = C \times t / 2 \qquad Formula 3$$

In the above formula, L represents the distance to the subject, and the unit is, for example, meter (m). C is a speed of light, and the unit, for example, is meter per second (m/s). t is time of flight, and the unit is, for example, second (s).

Then, the distance data generation unit 335 supplies each piece of the distance data to the distance data transmission circuit 340. According to Formula 3, as the frequency of the clock signal CLK_{VTPLL} is higher, the distance measurement cycle thereof is shorter, and distance measurement resolution is higher.

As described above, in the light detection element 200, the dToF scheme is used to directly obtain the time difference between a light emission timing and the light reception timing and measure the distance.

In the distance data transmission circuit 340, the frequency divider 341 frequency-divides the clock signal CLK_{TX}. The frequency divider 341 supplies the divided signal to the format changing unit 342 and the link portion 343.

The format changing unit 342 changes a format of the distance data as necessary. The format changing unit 342 supplies each piece of the changed distance data to the host device 500 via the link portion 343.

To summarize the configuration illustrated in the drawing, the VT PLL 322 generates the clock signal CLK_{VTPLL} indicating a timing for driving the light emitting unit 420. Note that the clock signal CLK_{VTPLL} is an example of a driving clock signal described in the claims, and the VT PLL 322 is an example of a driving clock generation unit described in the claims.

Furthermore, the OP PLL 323 generates the clock signal CLK_{OPPLL} having a higher frequency than the clock signal f_{IN}. Note that the clock signal CLK_{OPPLL} is an example of a high frequency clock signal described in the claims, and the OP PLL 323 is an example of a high frequency clock generation unit described in the claims.

The timing generation unit 333 supplies the clock signal CLK_{VT} to the light emission driving unit 430, which drives the light emitting unit 420, and the TDC 310.

In a case where the normal mode is set, the sequence control unit 331 transmits the control signal to the light emission driving unit 430 in synchronization with the clock signal CLK_{VTPLL} within the frequency change period.

On the other hand, in a case where the low power mode is set, the OP PLL 323 stops, and the sequence control unit 331 transmits the control signal to the light emission driving unit 430 in advance in synchronization with the clock signal CLK_{VTPLL} before start of the frequency change.

### Configuration Example of Light Emission Driving Unit

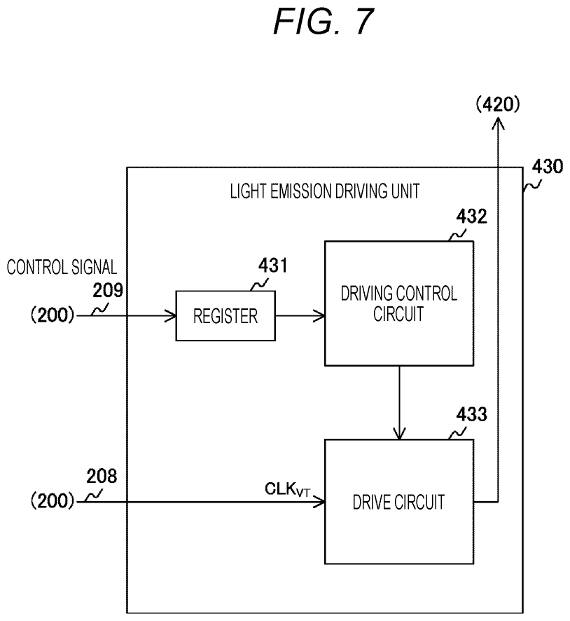

FIG. 7 is a block diagram illustrating a configuration example of the light emission driving unit 430 in the first embodiment of the present technology. The light emission driving unit 430 includes a register 431, a driving control circuit 432, and a drive circuit 433.

The register 431 holds the control signal. The driving control circuit 432 reads the control signal from the register 431 and controls the drive circuit 433 on the basis of the signal. In the low power mode, a control signal transmitted before the frequency change is started is held in the register 431, and the driving control circuit 432 reads the control signal from the register 431 during the frequency change.

The drive circuit 433 drives the light emitting unit 420 in synchronization with the clock signal CLK_{VT} under the control of the driving control circuit 432.

### Operation Example of Distance Measuring System

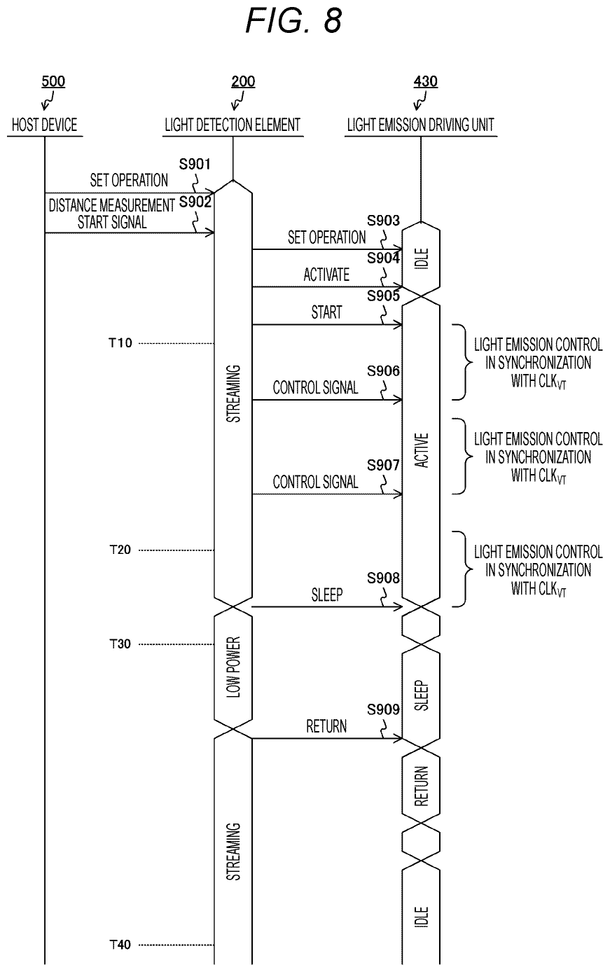

FIG. 8 is a sequence diagram illustrating an example of operation of the distance measuring system in the first embodiment of the present technology. The host device 500 sets the operation of the light detection element 200 (step S901) and supplies a distance measurement start signal instructing the start of distance measurement to the light detection element 200 (step S902). The light detection element shifts to the normal mode and starts streaming for continuously capturing a plurality of pieces of image data.

At the start of streaming, the light detection element 200 sets the operation of the light emission driving unit 430 (step S903), and activates the light emission driving unit 430 to return from an idle state (step S904). The light emission driving unit 430 shifts to an active state, and performs control to cause the light emitting unit 420 to emit light in synchronization with the clock signal CLK_{VT}.

After timing T10, the light detection element 200 changes a frequency and transmits a control signal to the light emission driving unit 430 (step S906). Furthermore, before timing T20, the light detection element 200 changes the frequency and transmits a control signal for switching a bank to the light emission driving unit 430 (step S907).

At a predetermined timing, the light detection element 200 instructs the light emission driving unit 430 to shift to a sleep state (step S908), and shifts to the low power mode. The light emission driving unit 430 shifts to the sleep state.

Then, after timing T30, the light detection element 200 shifts from the low power mode to the normal mode, and instructs the light emission driving unit 430 to return from the sleep state (step S909). The light emission driving unit 430 returns from a sleep mode and shifts to the idle state. A plurality of frames is generated in a period from the timing T30 to timing T40.

### Operation Example in Normal Mode

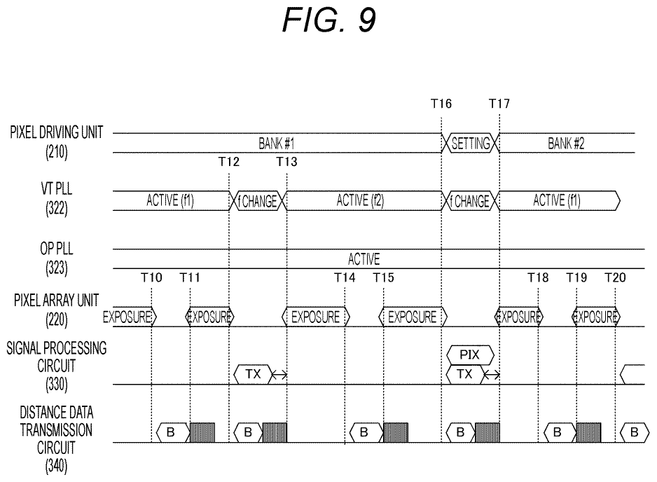

FIG. 9 is a timing chart illustrating an example of operation in the normal mode of the light detection element 200 in the first embodiment of the present technology. The drawing illustrates operation from the timing T10 to the timing T20 in FIG. 8.

In a period up to timing T16 in FIG. 8, the pixel driving unit 210 drives a pixel corresponding to the bank #1. In a period until timing T12, the VT PLL 322 generates the clock signal CLK_{VTPLL} having a frequency f1. The OP PLL 323 is in the active state and generates clock signal CLK_{OPPLL}. The pixel array unit 220 receives reflected light in an exposure period of a predetermined frame up to timing Ti.

In a blank period from the timing T10 to timing T11 at which exposure of the next frame starts, the distance data transmission circuit 340 buffers distance data and transmits the distance data after the timing T11. “B” in the drawing indicates the buffering operation. The pixel array unit 220 receives reflected light in an exposure period from the timing T11 to timing T12.

Then, in a blank period from the timing T12 to timing T13, the VT PLL 322 changes the frequency of the clock signal CLK_{VTPLL} from f1 to f2. During this blank period, the signal processing circuit 330 generates a control signal and transmits the control signal to the light emission driving unit 430 in synchronization with the clock signal CLK_{OPPLL}. “TX” in the drawing indicates the transmission operation of the control signal. Furthermore, after the transmission of the control signal is completed, a wait period until an analog circuit in the light emission driving unit 430 is stabilized is required. A line segment with arrows at both ends in the drawing indicates the weight period. Furthermore, the distance data transmission circuit 340 buffers and transmits distance data within the blank period.

The pixel array unit 220 receives reflected light in an exposure period from the timing T13 to timing T14. In a blank period from the timing T14 to timing T15, the distance data transmission circuit 340 buffers distance data and transmits the distance data after the timing T15. The pixel array unit 220 receives reflected light in an exposure period from the timing T15 to timing T16.

During a blank period from the timing T16 to timing T17, the pixel driving unit 210 sets a pixel corresponding to the bank #2 as a driving target according to the pixel setting signal. During this blank period, the VT PLL 322 changes the frequency of the clock signal CLK_{VTPLL} from f1 to f2. Furthermore, the signal processing circuit 330 transmits the pixel setting signal and the control signal within the blank period. “PIX” in the drawing indicates the transmission operation of the pixel setting signal.

After the timing T17, the pixel driving unit 210 drives the pixel corresponding to the bank #2. The pixel array unit 220 receives reflected light in an exposure period from the timing T17 to timing T18. In a blank period from the timing T18 to timing T19, the distance data transmission circuit 340 buffers distance data and transmits the distance data after the timing T19. The pixel array unit 220 receives reflected light in an exposure period from the timing T19 to the timing T20.

As illustrated in the drawing, a plurality of frames is sequentially generated while a certain bank is set. A blank period is provided between an exposure period of a certain frame and an exposure period of the next frame. The light detection element 200 can change the frequency of the clock signal CLK_{VTPLL} without switching the bank. The frequency is changed within the blank period, and the signal processing circuit 330 supplies the control signal to the light emission driving unit 430 within the blank period.

Furthermore, it is possible to switch the bank while changing the frequency. In that case, the signal processing circuit 330 transmits the pixel setting signal in addition to the control signal within the blank period during the frequency change. Note that the bank can also be switched without changing the frequency. In this case, it is sufficient for the signal processing circuit 330 to transmit only the pixel setting signal within the blank period.

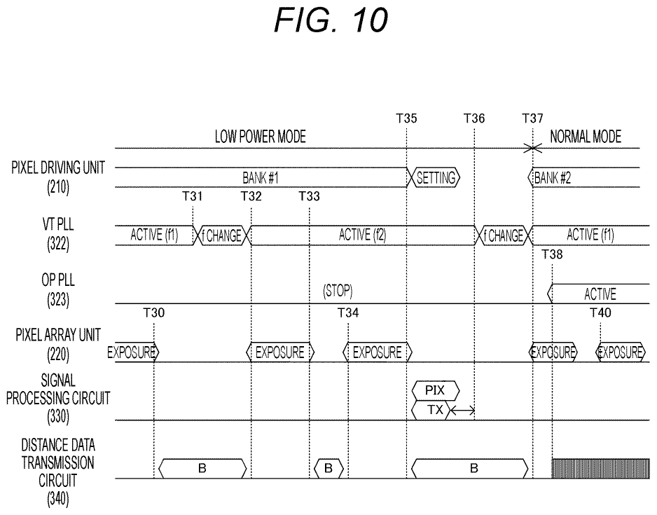

FIG. 10 is a timing chart illustrating an example of operation in the low power mode of the light detection element 200 in the first embodiment of the present technology. The drawing illustrates operation from the timing T30 to the timing T40 in FIG. 8.

In a period up to timing T35 in FIG. 10, the pixel driving unit 210 drives the pixel corresponding to the bank #1. The pixel array unit 220 receives reflected light in an exposure period until the timing T30. In a period until timing T31, the VT PLL 322 generates the clock signal CLK_{VTPLL} having a frequency f1.

During a blank period from the timing T30 to timing T32, the distance data transmission circuit 340 buffers distance data. However, the distance data is not transmitted due to the low power mode. During a change period from the timing T31 to the timing T32 in the blank period, the VT PLL 322 changes the frequency of the clock signal CLK_{VTPLL} from f1 to f2.

The pixel array unit 220 receives reflected light in an exposure period from the timing T32 to timing T33. In a blank period from the timing T33 to timing T34, the distance data transmission circuit 340 buffers distance data. The pixel array unit 220 receives reflected light in an exposure period from the timing T34 to timing T35.

Before a frequency change start timing T36 in a blank period from the timing T35 to timing T37, the pixel driving unit 210 sets the pixel corresponding to the bank #2 as a driving target according to the pixel setting signal. Furthermore, the signal processing circuit 330 transmits the pixel setting signal and the control signal in synchronization with the clock signal CLK_{VTPLL} within a period from the timing T35 to the timing T36 in the blank period. In a change period from the timing T36 to timing T37 in the blank period, the VT PLL 322 changes the frequency of the clock signal CLK_{VTPLL}. The distance data transmission circuit 340 buffers distance data within the blank period.

At the timing T37, the light detection element returns from the low power mode. After this timing T37, the pixel driving unit 210 drives the pixels corresponding to the bank #2. After timing T38, the OP PLL 323 being stopped shifts to the active state, and generates the clock signal CLK_{OPPLL}. Furthermore, the distance data transmission circuit 340 reads and transmits the buffered distance data in synchronization. After the timing T40, the light detection element 200 continues operating in the normal mode.

As illustrated in the drawing, a plurality of frames is sequentially generated in the low power mode. However, these frames are not output but buffered until the light detection element 200 returns to the normal mode. Although the frequency and the bank can be changed, the OP PLL 323 is stopped in the low power mode. Therefore, during the frequency change of the clock signal CLK_{VTPLL}, the clock signals CLK_{VTPLL} and CLK_{OPPLL} cannot be used, and only the clock signal INCK having a lower frequency than them can be used. In this regard, in the low power mode, the signal processing circuit 330 transmits the pixel setting signal and the control signal in advance in synchronization with the clock signal CLK_{VTPLL} before starting the frequency change.

Note that it is also possible to adopt a configuration in which the control signal and the like may be transmitted after the frequency change in a case where the wait period is short and the processing time is shorter if the control signal and the like are transmitted after the frequency change.

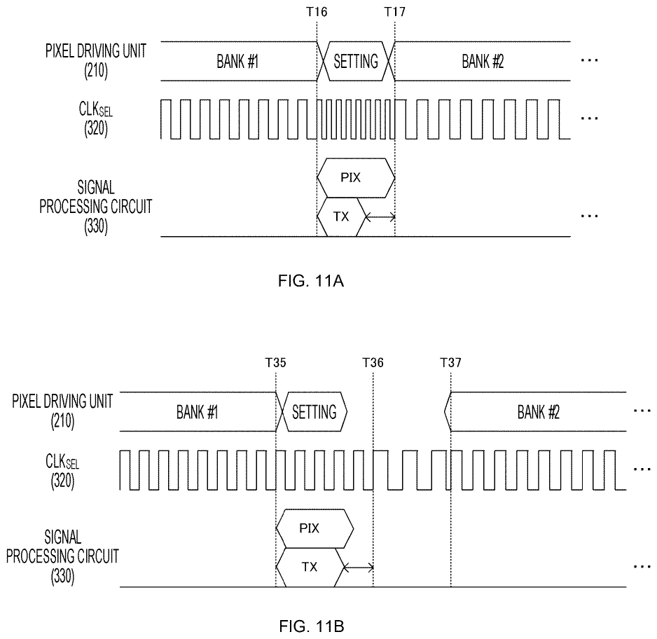

FIG. 11 is a timing chart illustrating an example of operation in a frequency change of the light detection element 200 in the first embodiment of the present technology. In the drawing, a is a timing chart illustrating an example of operation at the time of the frequency change in the normal mode. In the drawing, b is a timing chart illustrating an example of operation at the time of the frequency change in the low power mode.

As exemplified in a of the drawing, in the normal mode, the pixel driving unit 210 performs setting to change the driving target pixel in accordance with switching of the bank within the blank period from the timing T16 to the timing T17. During this blank period, the clock distribution unit 320 changes the frequency of the clock signal CLK_{VTPLL} and outputs the clock signal CLK_{OPPLL} having a higher frequency than the clock signal INCK as the clock signal CLK_{SEL}. The signal processing circuit 330 transmits the pixel setting signal and the control signal in synchronization with such a clock signal.

Furthermore, as exemplified in b of the drawing, in the low power mode, the pixel driving unit 210 performs setting to change the driving target pixel in accordance with switching of the bank within the period from the timing T35 to the timing T36. During this period before the frequency change, the signal processing circuit 330 transmits the pixel setting signal and the control signal in advance in synchronization with the clock signal CLK_{SEL} (CLK_{VTPLL}). The clock distribution unit 320 changes the frequency of the clock signal CLK_{VTPLL} within the change period between the timings T36 and T37, and outputs the clock signal INCK having a lower frequency as the clock signal CLK_{SEL}.

Here, a configuration in which the OP PLL 323 is not provided is assumed as a comparative example.

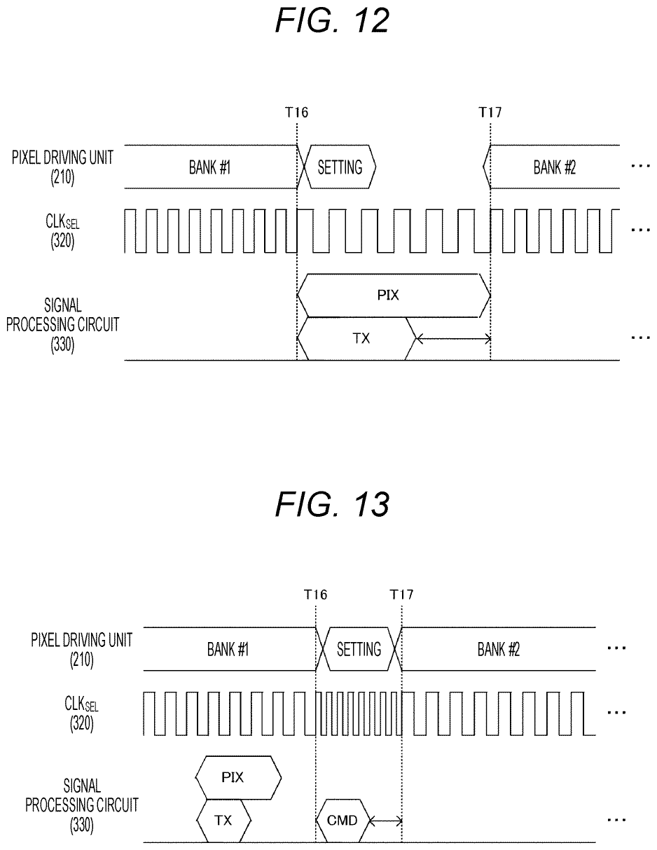

FIG. 12 is a timing chart illustrating an example of operation in a normal mode of a light detection element in the comparative example. In the normal mode, a pixel driving unit 210 performs setting to change a driving target pixel within a blank period from timing T16 to timing T17. It is assumed that a clock distribution unit 320 changes a frequency of a clock signal CLK_{VTPLL} within this blank period.

In the comparative example, since there is no OP PLL 323, the clock distribution unit 320 outputs a clock signal INCK having a lower frequency than the clock signal CLK_{VTPLL} as a clock signal CLK_{SEL} within the blank period. Therefore, a signal processing circuit 330 needs to transmit a pixel setting signal and a control signal in synchronization with the clock signal INCK, and there is a possibility that the blank period becomes long due to an increase in time for the transmission.

On the other hand, in the light detection element 200 provided with the OP PLL 323, the signal processing circuit 330 can transmit the pixel setting signal and the control signal in synchronization with the clock signal CLK_{OPPLL} within the blank period in the normal mode. Therefore, it is possible to shorten the blank period and improve the frame rate as compared with the comparative example.

Furthermore, although the OP PLL 323 is stopped in the low power mode, the clock signal CLK_{VTPLL} can be used at the time of transmission since the control signal and the like are transmitted before the start of the frequency change. Therefore, the blank period can be shortened as compared with a case where the control signal and the like are transmitted during the frequency change. As described above, in the present example, it is described that the clock of the VT PLL 322 is used before the frequency change since the blank period increases when the control signal and the like are transmitted using the clock signal INCK while the OP PLL 323 is stopped. However, since the aim is to shorten the blank period, another means for shortening the blank period than the transmission time using the clock signal INCK or that in the case of transmission using the VT PLL 322 before the frequency change, for example, a clock may be used at the time of frequency change if the clock other than the VT PLL 322 and the OP PLL 323 is present and a blank period decreases as compared with the above-described method in the example if transmission is performed using the clock other than the VT PLL 322 and the OP PLL 323 at the time of the frequency change of the VT PLL 322 in a stopped state of the OP PLL 323.

In this manner, the signal processing circuit 330 transmits the control signal and the like in synchronization with the clock signal CLK_{OPPLL} within the frequency change period according to the first embodiment of the present technology, and thus, the blank period can be shortened as compared with the comparative example in which the OP PLL 323 is not provided. Therefore, the frame rate can be improved.

### 2. Second Embodiment

In the first embodiment described above, the pixel setting signal and the control signal are transmitted during the blank period, but there is a possibility that the blank period increases as a data amount of these signals increases. The light detection element 200 of a second embodiment is different from that of the first embodiment in that a setting value is transmitted in advance before the start of frequency change.

FIG. 13 is a timing chart illustrating an example of operation in a normal mode of the light detection element 200 in the second embodiment of the present technology. It is assumed that the clock distribution unit 320 changes a frequency of the clock signal CLK_{VTPLL} within a blank period from timing T16 to timing T17.

The signal processing circuit 330 in the second embodiment transmits a pixel setting signal and a control signal that includes a changed setting value in advance before the frequency change start timing T16. In the drawing, “TX” indicates the operation of transmitting the control signal including the changed setting value. Furthermore, the light emission driving unit 430 of the second embodiment holds the changed setting value in the register 431.

The light emission driving unit 430 does not generate the clock signal CLK_{VTPLL}, and thus, it is not possible to grasp a timing to start the frequency change. Therefore, the signal processing circuit 330 transmits a control signal including a command for instructing the change of the setting value to the light emission driving unit 430 within the blank period during which the frequency is being changed. “CMD” in the drawing indicates the operation of transmitting the control signal including the command. The light emission driving unit 430 reads a setting value from the register 431 in accordance with the command, and drives the light emitting unit 420 on the basis of the setting value.

Note that the setting value before the change is an example of a first setting value described in the claims, and the changed setting value is an example of a second setting value described in the claims.

Since a data amount of the command does not change even if a data amount of the setting value increases, it is possible to shorten the blank period as compared with that in the first embodiment by transmitting only the command during the frequency change.

In this manner, the signal processing circuit 330 transmits the setting value in advance before the start of the frequency change and transmits the command during the frequency according to the second embodiment of the present technology, and thus, the blank period can be shortened as compared with that in the first embodiment.

### 3. Application Example to Mobile Body

The technology according to the present disclosure (present technology) can be applied to various products. For example, the technology according to the present disclosure may be implemented as a device mounted on any type of mobile body such as an automobile, an electric vehicle, a hybrid electric vehicle, a motorcycle, a bicycle, a personal mobility, an airplane, a drone, a ship, or a robot.

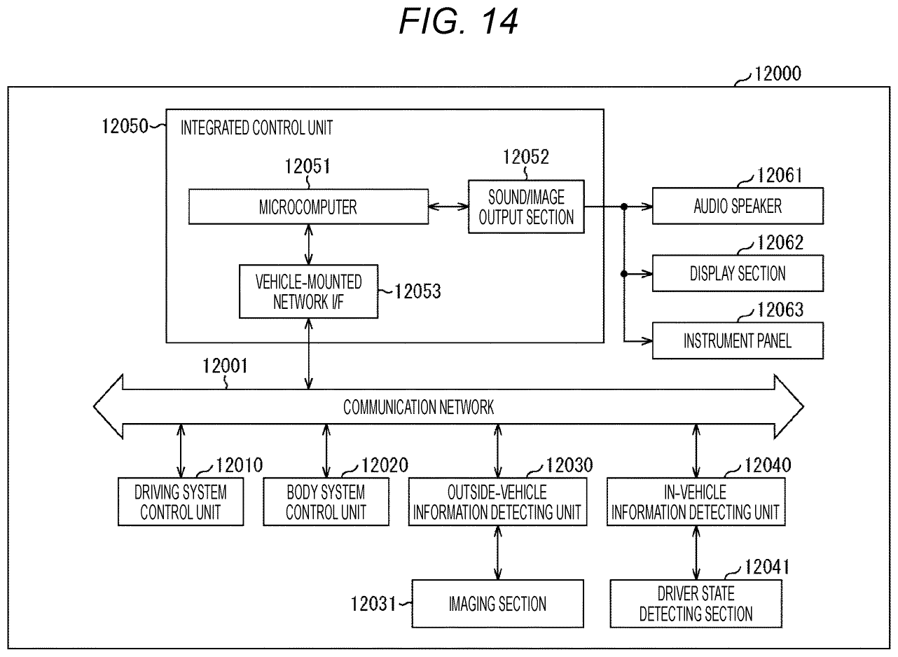

FIG. 14 is a block diagram illustrating an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 14, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 14, an audio speaker 12061, a display section 12062, and an instrument panel 12063 are illustrated as output devices. The display section 12062 may, for example, include at least one of an on-board display and a head-up display.

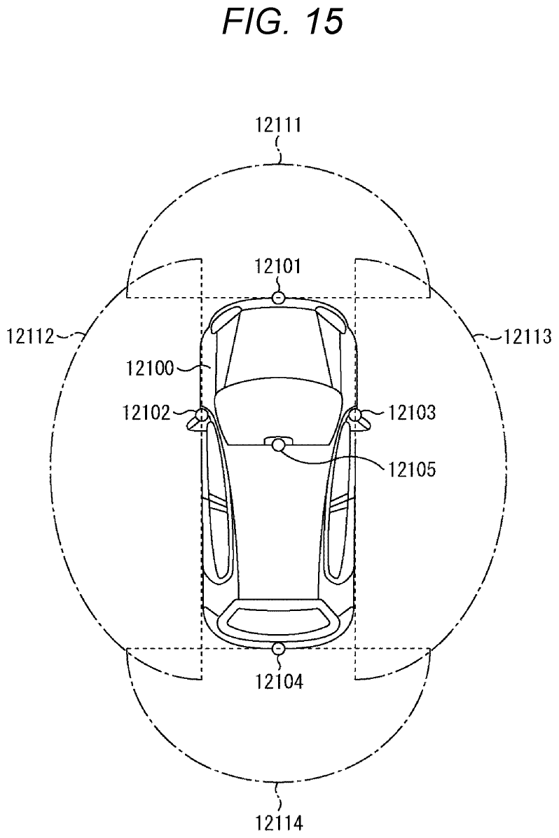

FIG. 15 is a diagram illustrating an example of an installation position of the imaging section 12031.

In FIG. 15, imaging sections 12101, 12102, 12103, 12104, and 12105 are included as the imaging section 12031.

The imaging sections 12101, 12102, 12103, 12104, 12105 are provided, for example, at positions such as a front nose, sideview mirrors, a rear bumper, and a back door of a vehicle 12100 as well as an upper portion of a windshield in the interior of the vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 15 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology of the present disclosure can be applied to the imaging section 12031 among the configurations described above. Specifically, the imaging device 100 in FIG. 1 can be applied to the imaging section 12031. When the technology according to the present disclosure is applied to the imaging section 12031, a frame rate of a frame including distance data can be improved, and safety of the vehicle control system can be improved.

Note that the embodiments described above show examples for embodying the present technology, and the matters in the embodiments and the matters specifying the invention in the claims have corresponding relationships, respectively. Similarly, the matters specifying the invention in the claims and matters with the same names in the embodiments of the present technology have correspondence relationships, respectively. However, the present technology is not limited to the embodiments, and can be embodied by applying various modifications to the embodiments without departing from the gist of the present technology.

Note that effects described in the present specification are merely examples and are not limited, and other effects may be provided.

Note that the present technology may also have the following configuration.

(1) A distance measuring device including:
a light emission driving unit that drives a light emitting unit in synchronization with a driving clock signal having a frequency higher than a predetermined frequency;
a driving clock generation unit that generates the driving clock signal;
a high frequency clock generation unit that generates a high frequency clock signal having a frequency higher than the predetermined frequency; and
a sequence control unit that transmits a predetermined control signal to the light emission driving unit in synchronization with the high frequency clock signal within a change period from the start to the end of a change of the frequency of the driving clock signal.

(2) The distance measuring device according to (1), in which
the high frequency clock generation unit stops in a case where a predetermined low power mode is set, and
the sequence control unit transmits the control signal to the light emission driving unit in synchronization with the high frequency clock signal within the change period in a case where the low power mode is not set, and transmits the control signal to the light emission driving unit in synchronization with the driving clock signal before the start of the change period in a case where the low power mode is set.

(3) The distance measuring device according to (1) or (2), in which
the control signal includes any of a first setting value, a second setting value, and a command for instructing a change from the first setting value to the second setting value,
the sequence control unit transmits the second setting value to the light emission driving unit in synchronization with the driving clock signal before the start of the change period, and transmits the command to the light emission driving unit in synchronization with the high frequency clock signal within the change period, and
the light emission driving unit holds the second setting value in a predetermined holding unit before the start of the change period, reads the second setting value from the holding unit when the command is transmitted, and drives the light emitting unit on the basis of the second setting value.

(4) The distance measuring device according to any one of (1) to (3), further including:
a pixel array unit in which pixels each generating a pulse signal in response to incidence of a photon are arranged; and
a time-to-digital converter that obtains a time of flight of light from the pulse signal and the driving clock signal.

(5) The distance measuring device according to (4), further including
a distance data generation unit that generates distance data indicating a distance to a subject on the basis of the time of flight.

(6) The distance measuring device according to any one of (1) to (5), further including
a selector that selects the driving clock signal outside the change period and supplies the driving clock signal to the sequence control unit, and selects the high frequency clock signal within the change period and supplies the high frequency clock signal to the sequence control unit.

(7) A light detection element including:
a driving clock generation unit that generates a driving clock signal having a frequency higher than a predetermined frequency and indicating a timing to drive a light emitting unit;
a high frequency clock generation unit that generates a high frequency clock signal having a frequency higher than the predetermined frequency;
a timing generation unit that supplies the driving clock signal to a light emission driving unit that drives the light emitting unit in synchronization with the driving clock signal; and
a sequence control unit that transmits a predetermined control signal to the light emission driving unit in synchronization with the high frequency clock signal within a change period from the start to the end of a change of the frequency of the driving clock signal.

### REFERENCE SIGNS LIST

100 Distance measuring module
101 Semiconductor substrate
110 Imaging device
111 Imaging-side optical system
200 Light detection element
201 Upper chip
202 Lower chip
210 Pixel driving unit
220 Pixel array unit
230 Pixel
231 SPAD
232 Detection circuit
300 Column signal processing unit
310 TDC
320 Clock distribution unit
321 TDC PLL
322 VT PLL
323 OP PLL
324 TX PLL
325 Selector
326, 341 Frequency divider
330 Signal processing circuit
331 Sequence control unit
332 Distribution circuit
333 Timing generation unit
334 Histogram generation unit
335 Distance data generation unit
340 Distance data transmission circuit
342 Format changing unit
343 Link portion
400 Light source device
402, 403 Chip
410 Light-emitting-side optical system
420 Light emitting unit
421 Light emitting element
430 Light emission driving unit
431 Register
432 Driving control circuit
433 Drive circuit
500 Host device
12031 Imaging section

1. A distance measuring device comprising:
a light emission driving unit that drives a light emitting unit in synchronization with a driving clock signal having a frequency higher than a predetermined frequency;
a driving clock generation unit that generates the driving clock signal;
a high frequency clock generation unit that generates a high frequency clock signal having a frequency higher than the predetermined frequency; and
a sequence control unit that transmits a predetermined control signal to the light emission driving unit in synchronization with the high frequency clock signal within a change period from a start to an end of a change of the frequency of the driving clock signal.

2. The distance measuring device according to claim 1, wherein
the high frequency clock generation unit stops in a case where a predetermined low power mode is set, and
the sequence control unit transmits the control signal to the light emission driving unit in synchronization with the high frequency clock signal within the change period in a case where the low power mode is not set, and transmits the control signal to the light emission driving unit in synchronization with the driving clock signal before the start of the change period in a case where the low power mode is set.

3. The distance measuring device according to claim 1, wherein
the control signal includes any of a first setting value, a second setting value, and a command for instructing a change from the first setting value to the second setting value,
the sequence control unit transmits the second setting value to the light emission driving unit in synchronization with the driving clock signal before the start of the change period, and transmits the command to the light emission driving unit in synchronization with the high frequency clock signal within the change period, and
the light emission driving unit holds the second setting value in a predetermined holding unit before the start of the change period, reads the second setting value from the holding unit when the command is transmitted, and drives the light emitting unit on a basis of the second setting value.

4. The distance measuring device according to claim 1, further comprising:
a pixel array unit in which pixels each generating a pulse signal in response to incidence of a photon are arranged; and
a time-to-digital converter that obtains a time of flight of light from the pulse signal and the driving clock signal.

5. The distance measuring device according to claim 4, further comprising
a distance data generation unit that generates distance data indicating a distance to a subject on a basis of the time of flight.

6. The distance measuring device according to claim 1, further comprising
a selector that selects the driving clock signal outside the change period and supplies the driving clock signal to the sequence control unit, and selects the high frequency clock signal within the change period and supplies the high frequency clock signal to the sequence control unit.

7. A light detection element comprising:
a driving clock generation unit that generates a driving clock signal having a frequency higher than a predetermined frequency and indicating a timing to drive a light emitting unit;
a high frequency clock generation unit that generates a high frequency clock signal having a frequency higher than the predetermined frequency;
a timing generation unit that supplies the driving clock signal to a light emission driving unit that drives the light emitting unit in synchronization with the driving clock signal; and
a sequence control unit that transmits a predetermined control signal to the light emission driving unit in synchronization with the high frequency clock signal within a change period from a start to an end of a change of the frequency of the driving clock signal.
